(19) United States
(12) Patent Application Publication
(10) Pub. No.: US 2025/0145755 A1
(43) Pub. Date: May 8, 2025

(54) FOAM AND ARTICLE USING THE SAME

(71) Applicant: LCY CHEMICAL CORP., Kaohsiung City (TW)

(72) Inventors: Richard Tien-Hua CHOU, Hockessin, DE (US); Yu-Yan LI, Kaohsiung City (TW); Wei-Chin HUANG, Kaohsiung City (TW); You-Min WANG, Kaohsiung City (TW)

(21) Appl. No.: 18/937,416

(22) Filed: Nov. 5, 2024

Related U.S. Application Data
(60) Provisional application No. 63/596,395, filed on Nov. 6, 2023.
(60) Provisional application No. 63/596,400, filed on Nov. 6, 2023.

(51) Int. Cl. C08F 297/04; C08F 8/04; C08F 236/10; C08J 9/00; C08J 9/10

(52) U.S. Cl. CPC C08F 297/048; C08F 8/04; C08F 236/10; C08J 9/0023; C08J 9/103; C08J 2203/184; C08J 2207/02; C08J 2353/02; C08J 2423/20; C08J 2431/04

(57) ABSTRACT

A foam is obtained by foaming a resin composition, which comprises a hydroxyl-terminated hydrogenated styrenic block copolymer of (A-B)n-OH, (B-A)n-OH, A(B-A)n-OH, or B(A-B)n-OH having a hydroxyl group at the terminal; wherein the A block comprises a styrene monomer unit and the B block comprises a conjugated diene monomer unit; wherein the hydroxyl-terminated hydrogenated styrenic block copolymer comprises 10˜60% by weight of the styrene monomer unit; 40 mol % or more of the conjugated diene monomer unit is hydrogenated; and the hydrogenated styrenic block copolymer has a weight average molecular weight of about 30000 to about 200000; the 1,2-vinyl bond content in the conjugated diene monomer unit of the hydroxyl-terminated hydrogenated styrenic block copolymer is in the range of 5 to 60 mole % prior to hydrogenation.

### CROSS-REFERENCE TO RELATED APPLICATIONS

This application claims the benefit of filing date of U.S. Provisional Application Ser. No. 63/596,395 filed Nov. 6, 2023, and U.S. Provisional Application Ser. No. 63/596,400 filed Nov. 6, 2023 under 35 USC § 119(e)(1).

### BACKGROUND OF THE INVENTION

### Field

This invention provides a foam which is especially suitable for shoe midsole, other types of sport foam pads, or daily necessities.

### Description of Related Art

Ethylene copolymers, such as ethylene-vinyl acetate (EVA), are widely used to fabricate foam products in footwear applications in a process involving first incorporate peroxide initiators and chemical blowing agents at a temperature of about 120° C. or less, and then molding in a mold for crosslinking the resin composition and then foaming at a temperature of about from 140° C. to 190° C. Ethylene alpha-olefin copolymers are also used for footwear foam applications. For example, U.S. Pat. No. 5,407,965 disclosed crosslinked substantially linear ethylene copolymer composition for foam application. U.S. Pat. No. 7,666,918B2 discloses a foamable compositions and foams comprise an ethylene/α-olefin interpolymer with multi-block of soft block and hard block. Blends of ethylene copolymers are also used for fabricating light weight foam for balancing foam properties.

Thermoplastic elastomers (TPE), such as thermoplastic polyurethane (TPU), thermoplastic polyether ester elastomer (TPEE), and polyether block amide (PEBA), is another category of materials suitable for producing light weight foam, such as footwear foam. TPE behaves like thermoset rubber, but melt processable like thermoplastics. It is composed of two phases: a soft phase which provides elastic properties, and a hard phase, which aggregates to form a physical crosslinking network. TPE of selected compositions may have the inherent melt strength for foaming without crosslinking, and the resulting foam has desirable foam properties. In general, TPE materials, such as thermoplastic polyurethane, cannot be fabricated into foam in the incumbent foaming process for making EVA foam. For example, EP3259306 discloses a process for producing foamed thermoplastic polyurethane particles, which contain impregnated physical blowing agents, such as nitrogen, to foam into bead foam.

Styrenic block copolymer (SBC) is a category of TPE suitable for producing light weight foam in the conventional footwear foam process. For producing SBC based foam, a peroxide crosslinking is needed for gaining melt strength for foaming. SBC with a glass transition temperature around 100° C. can be processed at temperatures of less than 120° C. for incorporating peroxide and chemical blowing agent, and the chemical structure of the soft block, namely butadiene, and/or isoprene, and the hydrogenated versions, can be crosslinked with peroxide initiator. For optimal crosslinking with peroxide, partial hydrogenated versions are preferred. Thus, styrenic block copolymers, such as partially hydrogenated SEBS, have been used for footwear foam, especially for modifying ethylene copolymers for attaining improved properties, such as impact resilience.

Despite the progress in applying SBC for foam applications, there is a continued need to explore novel SBC composition to further enhance its broad suitability for foam applications, especially for footwear foam applications. For example, US Patent Publication 2022/0380566 A1 discloses a foam based on hydrogenated styrenic diblock copolymer exhibiting improved processability, and the foam having high resilience.

Being a non-polar polymer, largely containing hydrogenated butadiene block, the foam based on hydrogenated SBC may have a lower bonding capability with other footwear components using environmental primers and adhesives in shoe manufacturing. Also it is of value to explore novel blend compositions including SBC, which provide differentiated foam performance to meet the diverse need for footwear foam applications.

### SUMMARY OF THE INVENTION

The objective of this invention is to provide a hydroxyl-terminated hydrogenated styrenic block copolymer that is most suitable for footwear foam applications as viewed from the following aspects.

The first aspect is that the hydroxyl-terminated hydrogenated block copolymer in foam form has excellent bonding capability with other footwear components. The adhesion of the foam component to other parts of the shoe requires great care and attention, as the durability of a shoe depends directly on the quality of the adhesion process of its components. Soft styrenic block copolymer, such as SEBS, suitable for footwear foam applications is high in content of non-polar ethylene-butylene units. The adhesion capability of a styrenic block copolymer-based foam can be a concern, which imposes a limit in its usage. The hydroxyl-terminated hydrogenated block copolymer attains excellent adhesion capability without a compromise in foam properties.

The second aspect is that the hydroxyl-terminated hydrogenated styrenic block copolymer serves as an enabling blending partner with other widely used foam resins, such as ethylene-based copolymers and polar thermoplastic elastomers. For meeting the ever-expanding performance requirements of a footwear foam, blending different foam resins of distinct chemical nature is mostly used for attaining key properties. The hydroxyl-terminated hydrogenated styrenic block copolymer provides additional synergy in blending with other foam resins.

The third aspect is that the hydroxyl-terminated hydrogenated styrenic block copolymer can attain improved compatibility with other polar polymers in the resin composition by reacting its terminal hydroxy group with at least one of functional group selected from the group consisting of anhydride, epoxy and isocyanate. This interaction also enhances the dispersion of additives, such as fillers, a crosslinking co-agent or a functional chain extender.

While not bounded by theory, this invention is based on the discovery that a hydroxyl-terminated hydrogenated styrenic block copolymer is most suitable for attaining the objectives of this invention as described above.

According to the objectives of this invention, the present invention discloses a hydroxyl-terminated hydrogenated styrenic block copolymer, a foam comprising the hydroxyl-terminated hydrogenated styrenic block copolymer, a resin composition comprising the hydroxyl-terminated hydrogenated block copolymer and an a ethylene-based copolymer, and a foam using the same, and the preparation thereof, also a resin composition comprising the hydroxyl-terminated hydrogenated block copolymer and a polar thermoplastic elastomer, and a foam using the same, and the preparation thereof.

(1). A foam obtained by foaming a resin composition, which comprises:
a hydroxyl-terminated hydrogenated styrenic block copolymer, wherein the hydroxyl-terminated hydrogenated styrenic block copolymer is a linear block copolymer of formula of:

(A-B)n—OH, (B-A)n—OH, A(B-A)n—OH, or B(A-B)n—OH
where n is 1 to 4, and having a hydroxyl group at the terminal, wherein the A block, prior to hydrogenation, comprises a styrene monomer unit; and the B block, prior to hydrogenation, comprises a conjugated diene monomer unit, wherein the hydroxyl-terminated hydrogenated styrenic block copolymer comprises 10 to 60 wt % of the A block, and a 1,2-vinyl bond content in the conjugated diene monomer unit of the hydroxyl-terminated hydrogenated styrenic block copolymer is in the range of 5 to 60 mole % prior to hydrogenation; after hydrogenation, 40 mol % or more of the conjugated diene monomer unit is hydrogenated; and the hydroxyl-terminated hydrogenated styrenic block copolymer has a weight average molecular weight of 30000 to 200000.

(2). A foam is obtained by foaming a resin composition comprising (a) the hydroxyl-terminated hydrogenated styrenic block copolymer aforementioned and (b) an ethylene-based copolymer, wherein the weight ratio of the component (a) to the component (b), (a/b), is from 90/10 to 10/90.

(3). A foam is obtained by foaming a resin composition, which comprises:
(a) the hydroxyl-terminated hydrogenated styrenic block copolymer aforementioned; and (b) a polar thermoplastic elastomer, wherein the weight ratio of the component (a) to the component (b), (a/b), is from 90/10 to 5/95.

(4). An article manufactured from the aforementioned foam is a component of footwear. In some embodiments, the component of the footwear is a midsole.

(5). A resin composition, which comprises:
a hydroxyl-terminated hydrogenated styrenic block copolymer, wherein the hydroxyl-terminated hydrogenated styrenic block copolymer is a linear block copolymer of formulas of:

(A-B)n—OH, (B-A)n—OH, A(B-A)n—OH, or B(A-B)n—OH
where n is 1 to 4, and having a hydroxyl group at the terminal, wherein the A block, prior to hydrogenation, comprises a styrene monomer unit; and the B block, prior to hydrogenation, comprises a conjugated diene monomer unit,
wherein the hydroxyl-terminated hydrogenated styrenic block copolymer comprises 10 to 60 wt % of the A block, and a 1,2-vinyl bond content in the conjugated diene monomer unit of the hydroxyl-terminated hydrogenated styrenic block copolymer is in a range of 5 to 60 mole % prior to hydrogenation; after hydrogenation, 40 mol % or more of the conjugated diene monomer unit is hydrogenated; and the hydroxyl-terminated hydrogenated styrenic block copolymer has a weight average molecular weight of 30000 to 200000.

(6) A use of the aforementioned resin composition for preparing a foam.

It should be noted that, in the present specification, when a component is described to have an element, it means that the component may have one or more of the elements, and it does not mean that the component has only one of the element, except otherwise specified.

In the present specification, except otherwise specified, the feature A “or” the feature B means the existence of the feature A or the existence of the feature B. The feature A “and/or” the feature B means the existence of the feature A, the existence of the feature B, or the existence of both the features A and B. The feature A “and” the feature B means the existence of both the features A and B. The term “comprise(s)”, “comprising”, “include(s)”, “including”, “have”, “has” and “having” means “comprise(s)/comprising but is/are/being not limited to”.

In the present disclosure, except otherwise specified, the terms “almost”, “about” and “approximately” usually mean the acceptable error in the specified value determined by a skilled person in the art, and the error depends on how the value is measured or determined. In some embodiments, the terms “almost”, “about” and “approximately” mean within 1, 2, 3 or 4 standard deviations. In some embodiments, the terms “almost”, “about” and “approximately” mean within ±20%, within ±15%, within ±10%, within ±9%, within ±8%, within ±7%, within ±6%, within ±5%, within ±4%, within ±3%, within ±2%, within ±1%, within ±0.5%, within ±0.05% or less of a given value or range. The quantity given here is an approximate quantity, that is, without specifying “almost”, “about” and “approximately”, it can still imply “almost”, “about” and “approximately”. In addition, the terms “in a range of a first value to a second value”, “from a first value to a second value” and the like mean the said range comprises the first value, the second value and other values between the first value and the second value.

Other novel features of the disclosure will become more apparent from the following detailed description when taken in conjunction with the accompanying drawings.

### BRIEF DESCRIPTION OF DRAWINGS

FIG. 1 shows the images of the peeled foam samples after the peel adhesion test.

### DETAILED DESCRIPTION OF THE INVENTION

The preferred embodiments of the present invention will be described in more detail as below. The present invention provides a foam obtained by crosslinking and foaming a resin composition comprising of a hydroxyl-terminated hydrogenated styrenic block copolymer. Also, the present invention provides a foam obtained by crosslinking and foaming a resin composition, which comprises the hydroxyl-terminated hydrogenated styrenic block copolymer aforementioned and an ethylene-based copolymer. Furthermore the present invention provides a foam obtained by foaming a resin composition, which comprises the aforementioned hydroxyl-terminated hydrogenated styrenic block copolymer and an polar thermoplastic elastomer. The main components used for making the foam of the present invention are described in detail below.

### (A) Hydroxyl-Terminated Hydrogenated Styrenic Block Copolymer

The hydroxyl-terminated hydrogenated styrenic block copolymer of the present disclosure, having the general formula of (A-B)n-OH, (B-A)n-OH, A(B-A)n-OH, or B(A-B)n-OH, having a hydroxyl group at the terminal, wherein the A block comprises a vinyl aromatic unit; and the B block comprises a conjugated diene monomer unit, wherein the hydroxyl-terminated hydrogenated styrenic block copolymer comprises 10 to 60 wt % of the A block; the 1,2-vinyl bond content in the conjugated diene monomer units is in the range of 5 to 60 mol % prior to hydrogenation; after hydrogenation 40 mol % or more of the conjugated diene unit is hydrogenated, and the hydroxyl-terminated hydrogenated styrenic block copolymer has a weight average molecular weight of 30000 to 200000.

The hydroxyl-terminated hydrogenated styrenic block copolymer is prepared by sequential polymerization of the A block and the B block in an anionic polymerization process containing a terminal hydroxyl group, and the hydroxyl group is located at either an end of the block A or an end of the block B.

From the perspective of manufacturing footwear foam, the hydroxyl-terminated hydrogenated styrenic block copolymer of the present disclosure is preferred to be a linear diblock copolymer of A-B—OH or B-A-OH. A hydroxyl-terminated hydrogenated styrenic diblock copolymer provides a much-improved processing capability in a foam production process involving a step of incorporating free radical initiators and foaming agents into the foam composition at a temperature of about 120° C. or lower, and then injecting molding of the composition containing the free radical initiators and foaming agents into a mold, wherein the crosslinking and the generation of blowing agent taking place in the mold is at a temperature from about 150° C. to 180° C. The foam is formed after the mold opens.

The A block of the hydroxyl-terminated hydrogenated styrenic block copolymer of the present invention, prior to hydrogenation, is a polymer block of a styrene unit; the B block, prior to hydrogenation, is a polymer block of a conjugated diene monomer unit selected from the group consisting of a butadiene unit, an isoprene unit, and a mixture thereof.

Optionally the A block of the hydroxyl-terminated hydrogenated styrenic block copolymer of the present invention, prior to hydrogenation, is a polymer block of a styrene monomer unit and a conjugated diene monomer unit, wherein the conjugated diene monomer unit is a butadiene unit, an isoprene unit, or a mixture thereof, and the content of the conjugated diene monomer unit in the A block is in the range of 0 wt % to 15 wt % based on a total weight of the A block. Optionally, the A block is a styrene monomer unit, and the B block is a butadiene monomer unit. Optionally, the B block, prior to hydrogenation, is a polymer block of a conjugated diene monomer unit and a styrene monomer unit, wherein the conjugated diene monomer unit is a butadiene unit, an isoprene unit, or a mixture thereof, and the content of the styrene monomer unit is in the range of 0 wt % to 20 wt % based on a total weight of the B block.

In some embodiments, the 1,2-vinyl bond content in the butadiene unit may be in a range of 5 to 60 mol % prior to hydrogenation. In one embodiment, the B block is a polymer block of butadiene, wherein a 1,2-vinyl bond content in the butadiene unit is in a range of 5 to 60 mol % prior to hydrogenation. In one embodiment, the A block is a polymer block of a styrene unit and a butadiene unit, wherein a 1,2-vinyl bond content in the butadiene unit is in a range of 5 to 60 mol % prior to hydrogenation. In some embodiment, the B block is a polymer block of a butadiene unit and a styrene unit, wherein a 1,2-vinyl bond content in the butadiene unit is in a range of 5 to 60 mol % prior to hydrogenation.

In some embodiments, the 3,4-vinyl bond content in the isoprene unit may be in the range of 5 to 60 mol % prior to hydrogenation. In one embodiment, the B block is a polymer block of isoprene, wherein the 3,4-vinyl bond content in the isoprene unit may be in the range of 5 to 60 mol % prior to hydrogenation. In one embodiment, the A block is a polymer block of a styrene unit and an isoprene unit, wherein the 3,4-vinyl bond content in the isoprene unit may be in the range of 5 to 60 mol % prior to hydrogenation.

In some embodiments, 60 to 95 mol % of the conjugated diene monomer unit is hydrogenated after hydrogenation.

In some embodiments, the A block is a polymer block of a styrene unit and a conjugated diene monomer unit. Specifically, the content of the conjugated diene monomer unit in the A block may be in a range from more than about 0 wt % to less than about 15 wt %, such as 3 wt %, 6 wt %, 9 wt %, 12 wt %, and 15 wt %.

In some embodiments, the B block is a polymer block of a butadiene unit and a styrene unit. Specifically, the content of the styrene monomer unit in the B block may be in a range from more than about 0 wt % to less than about 20 wt %, such as 5 wt %, 10 wt %, and 15 wt %.

In some embodiments, the hydroxyl-terminated styrenic block copolymer has a number average functionality (f(n)) in a range of 0.9 to 1.0.

In some embodiments, the hydroxyl-terminated styrenic block copolymer has a molecular weight distribution in a range of 1.0 to 1.05.

The method for manufacturing the hydroxyl-terminated styrenic block copolymer prior to hydrogenation is not particularly limited, and any known method can be used. Among the polymerization method, living anionic polymerization may be used, performed in a hydrocarbon solvent, and initiated by an organoalkali metal compound. For example, the above-mentioned polymer synthesis steps are clearly described in U.S. Pat. No. 3,823,203. The hydrocarbon solvent is not particularly limited, and any known solvent can be used. For instance, the hydrocarbon solvent may include aliphatic hydrocarbons such as n-hexane; alicyclic hydrocarbons such as cyclohexane; aromatic hydrocarbons such as xylene. The above-mentioned hydrocarbon solvent can be used singly or in combinations of two or more.

The initiator is not particularly limited, and initiators that are known to have anionic polymerization activity with vinyl aromatic monomers, such as styrene, and conjugated diene monomers, such as butadiene, can be applied such as aliphatic hydrocarbon alkali metal compounds, aromatic hydrocarbon alkali metal compounds, and organic amino alkali metal compounds. Alkali metals used as the initiator may include lithium, sodium, and potassium. In some embodiments, the initiator may be aliphatic hydrocarbon alkali metal, such as n-butyl lithium.

The polymerization process of preparing the hydroxyl-terminated styrenic block copolymer may be carried out similar to those used for anionic polymerizations. The polymerization may be carried out at a temperature from around 0° C. to around 180° C., more preferably from about 30° C. to about 150° C., and the most preferably from about 30° C. to about 90° C. It is carried out in an inert atmosphere preferably nitrogen, and may also be accomplished under pressure within the range of from about 0.5 to about 10 bars. The polymerization process generally requires less than 12 hours, depending upon the temperature, the concentration of the monomer components, the molecular weight of the polymer, etc.

The methods for chain-end functionalization mentioned above are clearly described in U.S. Pat. No. 5,693,711. For example, the styrenic triblock copolymer having a hydroxyl group at the terminal can be prepared as follows. First, styrene is introduced to produce the styrene block, followed by the introduction of butadiene to form the mid-block. Next, styrene is introduced again to form the terminal block. Thirdly, an alkylene oxide, such as ethylene oxide or propylene oxide, is introduced as a capping agent to create a hydroxyl group at the terminal. This is followed by the addition of a compound with active hydrogen, such as alcohols, carboxylic acids, or water, to terminate the polymerization process. In some embodiments, the alkylene oxide is selected from one or more of ethylene oxide, propylene oxide, 1, 2-butylene oxide, and 1, 2-pentane oxide. Ethylene oxide is preferred as the capping agent to create the hydroxyl group.

The hydrogenation of the hydroxyl-terminated styrenic block copolymer having a hydroxyl group at the terminal can be carried out in a process similar to known hydrogenation processes. For example, such hydrogenation has been accomplished using methods such as reported in U.S. Pat. Nos. 3,595,942 and 3,700,633. These methods of hydrogenation employ suitable catalysts. This mentioned catalyst may comprise a Group VIII metal such as nickel or cobalt which is combined with a suitable reducing agent such as an aluminum alkyl or hydride of a metal selected from Groups I-A, II-A and III-A of the Periodic Table of the Elements, particularly lithium, magnesium or aluminum.

The hydrogenation process is not particularly limited, but the hydrogenation is typically carried out at a temperature from 0° C. to 180° C., and more preferably from 30° C. to 150° C. The hydrogen pressure used in this process is not particularly limited, but is typically from 0.1 to 20 MPa, 0.2 to 15 MPa or 0.3 to 5 MPa. The reaction time is typically from 1 minute to 10 hours or from 10 minutes to 5 hours.

The hydrogenation process may be performed by a batch process, continuous process, or a combination thereof. If it is necessary, the catalyst residue may be removed. The hydrogenated polymer may be isolated by pouring into hot water while stirring, and the organic solvent may be removed by steam stripping.

In some embodiments, the microstructure of the conjugated diene segment of the hydrogenated styrenic copolymer, such as vinyl bond content and the styrene content prior to hydrogenation, and the degree of hydrogenation after hydrogenation, may be measured using proton nuclear magnetic resonance (¹H-NMR) method. Moreover, the weight average molecular weight may be determined by gel permeation chromatography (GPC).

### (B) Ethylene-Based Copolymer

In some embodiments of the present disclosure, the foam resin composition may comprise the aforesaid hydroxyl-terminated hydrogenated styrenic block copolymer and an ethylene-based copolymer. In some embodiments, the weight ratio of the hydroxyl-terminated hydrogenated styrenic block copolymer to the ethylene-based copolymer is from 90/10 to 10/90.

In some embodiments, a weight ratio of the hydroxyl-terminated hydrogenated styrenic block copolymer to the ethylene-based copolymer may be from 50/50 to 10/90. In some embodiments, the weight ratio of the hydroxyl-terminated hydrogenated styrenic block copolymer to the ethylene-based copolymer may be from, for example, 50/50 to 10/90, 40/60 to 10/90, 35/65 to 10/90 or 30/70 to 10/90.

In the present disclosure, the ethylene-based copolymer is not particularly limited, and a known ethylene-based copolymer can be used. For instance, the suitable ethylene-based copolymer may be an ethylene-vinyl acetate copolymer (EVA) obtained by copolymerization of ethylene and vinyl acetate; an ethylene-α-olefin based random copolymer; an olefin block copolymer comprising a polymer block of ethylene and a polymer block of C4-C8 α-olefins; a polyethylene or a combination thereof. In some embodiments, the polyethylene is a linear low density polyethylene.

In some embodiments, the ethylene-based copolymer may be an ethylene-vinyl acetate copolymer, and a content of vinyl acetate is in a range of about 15 to 40 wt % based on a total weight of the ethylene-vinyl acetate copolymer. In some embodiments, the ethylene-based copolymer may be the ethylene-α-olefin-based random copolymer, wherein the α-olefin may include 1-butene, 1-pentene, 1-hexene, 1-octene, or a combination thereof, such as TAFMER® olefin copolymers available from Mitsui Chemicals and ENGAGE® from Dow Chemical Company. In some embodiments, the ethylene-based copolymer is an ethylene alpha-olefin based random copolymer consisting of an ethylene unit and an octene unit.

In some embodiments, the ethylene-based copolymer may be the olefin block copolymer, such as INFUSE® olefin block copolymers available from Dow Chemical Company. In one embodiment, the ethylene-based copolymer is an olefin block copolymer comprising a polymer block of an ethylene unit. In some embodiments, the ethylene-based copolymer is an olefin block copolymer comprising a polymer block of ethylene and a polymer block of an octene unit. The preferred olefin block copolymer exhibits the melting point in the range of 115° C. to 130° C., and the density in the range of 0.875 g/cc to 0.945 g/cc.

In some embodiments, the ethylene-based copolymer may further comprise high density polyethylene and low density polyethylene for minor property adjustment.

### (C) Polar Thermoplastic Elastomer

In some embodiments of the present disclosure, the resin composition for preparing foam may comprise the aforementioned hydroxyl-terminated hydrogenated styrenic block copolymer and TPU (thermoplastic polyurethane). In some embodiments, the weight ratio of the hydroxyl-terminated hydrogenated styrenic block copolymer to the TPU is from 90/10 to 10/90.

In some embodiments, the weight ratio of the hydroxyl-terminated hydrogenated styrenic block copolymer to the TPU may be from 50/50 to 10/90. In some embodiments, the weight ratio of the hydroxyl-terminated hydrogenated styrenic block copolymer to the TPU may be from, for example, 50/50 to 10/90, 40/60 to 10/90, 35/65 to 10/90 or 30/70 to 10/90.

In the present disclosure, the structure of TPU is not particularly limited, and a known copolymer preparing from diisocyanate, chain extender or short-chain diol, and polyol or long-chain diol can be used. It is a segmented block copolymer composed of soft and hard segments. The hard segments are isocyanates and can be classified as either aliphatic or aromatic depending on the type of isocyanate. The soft segments are made of a polyol or long-chain diol. Moreover, there may be short-chain diol that acts as a chain extender in TPU structure.

In some embodiments of the present disclosure, the foam resin composition may comprise the aforesaid hydroxyl-terminated hydrogenated styrenic block copolymer and TPEE (thermoplastic polyester elastomer, also known as thermoplastic copolyester. One of the most famous tradenames is Hytrel® which is manufactured by DuPont™. In some embodiments, the weight ratio of the hydroxyl-terminated hydrogenated styrenic block copolymer to the TPEE is from 90/10 to 10/90.

In some embodiments, a weight ratio of the hydroxyl-terminated hydrogenated styrenic block copolymer to the TPEE may be from 50/50 to 5/95. In some embodiments, the weight ratio of the hydroxyl-terminated hydrogenated styrenic block copolymer to the TPEE may be from, for example, 50/50 to 10/90, 40/60 to 10/90, 35/65 to 10/90 or 30/70 to 10/90.

In the present disclosure, the structure of TPEE is not particularly limited, and a known copolymer containing alternating segments of hard and soft blocks. The hard segments are typically made from polyester with aromatic rings, which gives TPEE its strength and thermal resistance. The soft segments are usually made from polyether or polyester with aliphatic chain, which impart flexibility and elasticity to the material. In some embodiments, TPEE is a kind of linear segmented copolymer containing PBT (polybutylene terephthalate) polyester hard segment (crystalline phase) and aliphatic polyester or polyether (amorphous phase) soft segment.

In some embodiments of the present disclosure, the foam resin composition may comprise the aforementioned hydroxyl-terminated hydrogenated styrenic block copolymer and PEBA (polyether block amide) One of the most famous tradenames is Pebax® which is manufactured by Arkema. In some embodiments, the weight ratio of the hydroxyl-terminated hydrogenated styrenic block copolymer to the PEBA is from 90/10 to 10/90.

In some embodiments, a weight ratio of the hydroxyl-terminated hydrogenated styrenic block copolymer to the PEBA may be from 50/50 to 5/95. In some embodiments, the weight ratio of the hydroxyl-terminated hydrogenated styrenic block copolymer to the PEBA may be from, for example, 50/50 to 10/90, 40/60 to 10/90, 35/65 to 10/90 or 30/70 to 10/90.

In the present disclosure, the structure of PEBA is not particularly limited, and a known copolymer containing alternating segments of hard and soft blocks. The hard segments are typically made from polyamide (PA), which gives PEBA its strength and thermal resistance. The soft segments are usually made from polyether, which imparts softness and elasticity.

In the present invention, the foam may be obtained by a process comprising injection molding the resin composition in an injection mold, wherein the process includes: crosslinking the resin composition using an organic peroxide initiator, and foaming the resin composition using a chemical foaming agent, wherein the temperature of crosslinking in the injection mold is about 150° C. to about 200° C.

### (D) Organic Peroxide

In the present invention, the organic peroxide used for crosslinking foam resin composition is not particularly limited, and any known organic peroxide can be used. For example, dicumyl peroxide (DCP), 2,5-dimethyl-2,5-di-(t-butylperoxy)hexane, bis(1-(tert-butylperoxy)-1-methylethyl)-benzene (BIPB) and di-t-butylperoxide are preferred and used widely in the preparation of a foam. The amount of the organic peroxide not particularly limited, but is preferably from 0.01 to 10 parts, more preferably from 0.1 to 3 parts, based on 100 weight parts of the total amount of the resin composition.

### (E) Chemical Foaming Agent

The foaming agent of the present invention is not particularly limited, and any known foaming agent can be used. In some embodiments, the foaming agent may be organic type foaming agent or inorganic type thermal decomposable foaming agents. Among these foaming agents, the most well-known organic types forming agent may include azodicarbonamide (AC), 4,4′-oxybis(benzenesulfonylhydrazide), p-toluenesulfonyl semicarbazide, N, N′-dinitrosopentamethylenetetramine, diphenylsulfone-3,3′-disulfonyl hydrazide (DPSDSH), or trihydraznotriazine; specific examples of inorganic type thermal decomposable foaming agents may include sodium hydrogencarbonate, ammonium hydrogencarbonate, sodium carbonate, or ammonium carbonate. Among the above-mentioned foaming agent types, azodicarbonamide (AC) is most preferred and used in the present invention. The amount of the of foaming agent used is not particularly limited, but is preferably from 0.5 to 10 parts based on 100 weight parts of the total amount of the resin composition.

### (F) Other Additives

It is not particularly limited; however, if necessary, in addition to the above-mentioned components, the resin composition for foam in the present invention may further contain crosslinking co-agent, functional chain extender, organometallic compound, filler, thermal and weather stabilizer, pigments, etc. The functional chain extender comprising at least one of functional group selected from the group consisting of anhydride, epoxy and isocyanate that are capable to react with the terminal hydroxyl group of the hydroxyl-terminated hydrogenated styrenic block copolymer may also be used in crosslinking the resin composition.

For the purpose of accelerating the rate of crosslinking reaction, a crosslinking co-agent can be applied into the present invention. For example, the crosslinking co-agents may include triallyl isocyanurate, triallyl cyanurate, ethylene glycol dimethacrylate, or vinyl butyrate. For making foam pores be finer or more uniform, the addition of the organometallic compound can be used in the foam. For example, the preferred organometallic compounds may include zinc diacrylate and zinc dimethacrylate, which can also serve as crosslinking co-agents. For the purpose of cost-saving, adjusting hardness or modulus, and nucleation, fillers are often included in the resin composition. Examples of fillers may include clay, silicon dioxide, talc, titanium dioxide, zinc oxide, or calcium carbonate.

To enhance the foam product durability, one of the most general methods is adding thermal and weather stabilizers into resin composition. Thermal stabilizers may include phosphorus-based type, such as Irgafos 168. Weathering stabilizer may include hindered phenol-based type, such as pentaerythritol tetrakis[3-[3,5-di-tert-butyl-4-hydroxyphenyl]propionate. On the other hand, examples of the pigments may include azo-based type, phthalocyanine-based type, oxide-based type, chromate-based type, molybdate-based type, inorganic type, and carbon black.

### Preparation of Resin Compositions for Foaming

The resin composition of the present embodiment can be produced by using a kneading machine to first melt and blend the above-mentioned components of the hydroxyl-terminated hydrogenated styrenic block copolymer and the ethylene-based copolymer, or the polar thermoplastic elastomer optionally, and then incorporate the organic peroxide and the foaming agent, and other additives, such as fillers are included. The operation is carried out below 120° C. to avoid the premature decomposition of peroxide and foaming agent.

The method of melt mixing and blending is not particularly limited, and known methods can be used. For example, an extruder such as a single-screw extruder, a twin-screw extruder, a multi-screw extruder, a Henschel mixer, a Banbury mixer, a roll mill, and a kneading can be applied to the present invention. In the present embodiment, a melt mixing method using a kneader is preferred.

After the melt-mixing process, the shape of the resin composition of the present embodiment is not particularly limited. For instance, it may be formed into a pellet shape, a flake shape, a strand shape, or a chip shape, etc. For example, it may be mixing the components by a granulator or the like to form a pellet. For example, after kneading each component of the resin composition, a roll mill is used to form a sheet ready for foaming.

### The Polymer Structure Identification of the Hydroxyl Terminated Hydrogenated Styrenic Block Copolymer is Determined as Follows.

### Molecular Weight and Molecular Weight Distribution

A weight average molecular weights (Mw) and a number average molecular weights (Mn) were both tested and determined by gel permeation chromatography (GPC) instrument. The molecular weight value of the peak in the chromatogram was calculated by a calibration curve of commercially available standard polystyrenes. The molecular weight distribution (Mw/Mn) was determined based on the weight average molecular weights (Mw) and number average molecular weights (Mn). More detail about the testing steps and instrument information are described as below. The apparatus is commercial GPC system including PDI and refractive index detector provided by Waters Corporation. Generally, tetrahydrofuran (THF) is selected as the solvent. Measuring temperature is maintained at 40° C. The flow rate is 1 ml/min, and the injection amount is 100 μl. The ratio of hydrogenated block copolymer/THF is 3 mg/15 cc.

### Styrene Content and Vinyl Bond Content

The styrene content and the vinyl bond content of the hydrogenated styrenic diblock copolymer prior to hydrogenation are measured by ¹H-NMR spectrum employing a VARIAN 400 provided by Agilent Technologies, Inc. Generally, deuterated chloroform is selected as the solvent.

### Degree of Hydrogenation

The degree of hydrogenation may be calculated from the rate of decrease in the unsaturated bond signals in the 1H-NMR spectrum, and the calculation is written as follows.

Degree of hydrogenation (mol %)=B/(A+B)×100%
A: Mole number of unhydrogenated conjugated diene monomer unit
B: Mole number of hydrogenated conjugated diene monomer unit
   Number Average Functionality (f(n))

The number average functionality of the hydroxyl-terminated hydrogenated styrenic block copolymer can be calculated from the 1H-NMR spectrum and GPC.

$$f ( n ) = \frac{C \times D}{E}$$

wherein, F(n): The number average functionality;
C:

$$\frac{\begin{matrix}the number average molecular weight ( Mn ) \\ of styrenic block copolymer \times polystyrene content\end{matrix}}{styrene molecular weight}$$

D: the number of moles of methylene;
E: the number of moles of styrene monomer unit.

### Melt Flow Index

MFI (melt flow index) is measured according to ASTM-D1238.

In some embodiments of the present invention, the obtained foam has at least one of the following properties: a foam density in a range of 0.1 to 0.5 g/cm³, impact resilience within a range of 50% to 80%, and a hardness (Asker C) in a range of 20 to 70.

The Mechanical Properties of the Crosslinked Foam were Evaluated as Follows.

### Specific Gravity

The once crosslinked foam was punched out into a circle having a diameter of 2.54 cm and a thickness of 1 cm, and was measured by an electronic hydrometer (MS-204S, manufactured by Mettler Toledo Co., Ltd.).

### Hardness

Bases on ASTM D2240, the hardness (Asker C) of the once crosslinked foam was measured using an Asker hardness meter C hardness tester (Type C, manufactured by Polymer Co., Ltd.), and the value was read within 1 second. Also, the average value (arithmetic mean) of five points was taken as the hardness.

### Split Tear Strength

The split tear strength of the once crosslinked foam is determined according to ASTM D3574 F.

### Tensile Strength

The tensile strength at break of the once crosslinked foam is determined according to ASTM D412.

### Elongation

The elongation at break of the once crosslinked foam is determined according to ASTM D412.

### Compression Set

The once crosslinked foam was punched out into a circle having a diameter of 2.54 cm, and was used as a test piece and compressed to a thickness of 50%. After holding at 50° C. for 6 hours, the pressure was released, and the thickness after 1 hour was measured. The magnitude of the residual deformation was evaluated.

### Impact Resilience

The impact resilience of the crosslinked foam is determined according to ASTM-D2632 in a vertical rebound apparatus. Impact resilience is determined as the ratio of rebound height to drop height of a metal plunger of prescribed mass and shape which is allowed to fall on the foam specimen.

### Shrinkage

The shrinkage of the foam is determined according to ASTM-D1917. The sample is cut into square shape with 5 cm length and 1 cm thickness specimen. The original length of specimen is recorded first, and specimen is put into oven for 70° C./40 min. After heating, specimen is taken out from oven, and cooled at room temperature. After cooling, the length is measured again, and the length change is recorded as shrinkage.

### Adhesion Evaluation of the Foams Containing Hydroxyl Terminated Hydrogenated Block Copolymers

The adhesion evaluation of the foam was conducted by peel testing of laminated foam and vulcanized specimen after being treated with a primer and a PU adhesive. The components employed for the bonded specimen in the test are listed below:
1). the foam samples with thickness of 10 mm of both Comparative Examples without the hydroxyl terminated block copolymer and Examples containing the hydroxyl terminated block copolymer are listed in Table 2;
2). the vulcanized rubber flat sheet with 2 mm thickness, provided by Yong-Shan Enterprise Co., Ltd. (Taiwan), was used to be bonded with the foam samples;
3). <Primer system> The primer used is Greco 001A and 001B, obtained from Great Eastern Resins Industrial Co. Ltd., Taiwan.
4). <PU adhesion system> The PU-based adhesive is Greco 6608; the hardener is Greco 368; wherein the PU-based adhesive and the hardener are obtained from Great Eastern Resins Industrial Co. Ltd. (Taiwan).

The preparation of the bonded specimen of the foam sample and the vulcanized rubber flat sheet via cementation by using the primer and the PU adhesive was conducted as following steps:
1). the foam sample sheet and the vulcanized rubber flat sheet were treated by polishing and cleaning process. The polishing treatment was conducted by a grinder to achieve the desired roughness or smoothness on the sample surface. The cleaning process was conducted by ethanol. After the polishing and cleaning treatment, the sample sheets were dried in oven at 70° C. for 20 minutes;
2). After water-based primer Greco 001A and 001B were well mixed in weight ratio of 100/2, the primer solution was brushed onto the polished surfaces of the foam sample and the vulcanized rubber sheet. These sample sheets are then put into oven at 70° C. for 4 minutes to let solvent be evaporated;
3). the brand name of PU-based adhesive is 6608, and the hardener brand name is 368. Before brushing the adhesive onto sample, these two types of materials should be mixed by 100/5 weight portion. After the adhesive and hardener are well mixed, this mixture is brushed onto the sponge and vulcanized rubber sheets surfaces which are already treated by primer. These sample sheets are then put into oven at 70° C. for 4 minutes to let solvent be evaporated.
4). The treated foam sheet surface was attached to the treated surface of the vulcanized rubber sheet, and a fixed press was applied on the attached sheet sample for several seconds to let foam sample be bonded to vulcanized rubber sheet. After placing the bonded sheet sample at room temperature for more than 24 hours, the sheet sample is finally cut into a test specimen with 15 cm length and 25 mm width.

Referring to ASTM D1876, the T-peel test method is applied to evaluate the bonding strength between the foam/vulcanized rubber sheet. A tension machine (Instron 3365) is used to measure the bonding strength in a unit of kgf/cm.

### Materials of Examples and Comparative Examples

### Ethylene-Based Copolymers

EVA 659 is an ethylene-vinyl acetate copolymer of 25 wt % vinyl acetate content and a melt flow index of 3 g/10 min as measured at 190° C./2.16 kgf, manufactured by USI Corporation, trade name “UE659”.

OBC 9530 is an olefin block copolymer; specifically, OBC 9530 is an ethylene/1-octene block copolymer with a melt flow index of 5.0 g/10 min as measured at 190° C./2.16 kgf, a density of 0.887 g/cm³, and a melting point of 119° C., manufactured by Dow Chemical Company, trade name “Infuse 9530”.

POE 8450 is an ethylene/1-octene random copolymer, a melt flow index of 3.0 g/10 min as measured at 190° C./2.16 kgf, hardness 0.902 g/cm³, manufactured by Dow Chemical Company, trade name “Engage 8450”.

### Organic Peroxide

Bis(1-(tert-butylperoxy)-1-methylethyl)-benzene (BIPB) is manufactured by Arkema Group.

### Chemical Foaming Agent

Azodicarbonamide (AC) is manuactured by Kumyang Corporation.

### Other Additives

Calcium carbonate is manufactured by Yuncheng Chemical Industrial CO., LTD.; ZnO (Zinc Oxide) is manufactured by Diamonchem International Co., Ltd.; and Stearic Acid is manufactured by Vulchem Inc.

In some embodiments of the present invention, the obtained foam can be used as a component of footwear such as a midsole.

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

The present disclosure will be described in more detail through embodiments, but these embodiments are not intended to limit the scope of the disclosure. Unless otherwise specified, in the following preparation examples, examples and comparative examples, the temperature is in degrees Celsius, and the parts and percentages are by weight. The relationship between parts by weight (or mass) and parts by volume is like the relationship between kilograms and liters.

The Hydroxyl-Terminated Hydrogenated Block Copolymer Samples were Prepared as Follows.

### SEB-OH-A

SEB-O-A, a hydrogenated styrene-butadiene-styrene diblock copolymer having a hydroxyl group at the terminal was prepared, and characterized as follows. First, 4800 g of cyclohexane, 15.7 millimoles of n-butyllithium, and 166 millimoles of tetrahydrofuran (THF) were charged into a reactor of 10 liter size equipped with a heater and a stirrer. Secondly, 160 g styrene was added into the solvent to proceed the anionic polymerization at temperature of about 50° C. Thirdly, 640 g of butadiene was added into the reactor. After the reaction of butadiene was complete, 1.2 g of propylene oxide was added, to form a styrene-butadiene di-block copolymer with a hydroxyl group at the terminal. This was followed by the addition of methanol to terminate the polymerization. The SB—OH copolymer had a styrene content of 20 wt % and the 1,2-vinyl bond content in the butadiene block was about 38 mol %.

The SB—OH copolymer obtained by the above-mentioned steps was then hydrogenated in a pressure vessel using a nickel-2-ethylhexanoate/TEAL catalyst and hydrogen gas. The temperature for the hydrogenation process was controlled from about 40° C. to 100° C. After about 80 mol % of the butadiene block was hydrogenated, the hydrogenation reaction was terminated. And then, the obtained sample was washed with hot acidic water to remove residual catalyst. Finally, the block copolymer was isolated by coagulation in hot water and then dried. The yield of the hydroxyl-terminated hydrogenated styrene-butadiene diblock copolymer (SEB-OH) copolymer was about 80%.

According to analysis, the obtained SEB-OH-A copolymer had degree of hydrogenation of 79 mol %, a weight average molecular weight of about 75,000, a molecular weight distribution (weight average molecular weight/number average molecular weight) of 1.03, and MFI of 0.4 measured at 190° C./5 kgf.

### SEBS-OH-A

SEBS-OH-A is a hydrogenated styrene-butadiene-styrene triblock copolymer having a hydroxyl group at the terminal as described how it was prepared, and characterized in detail. First, 4800 g of cyclohexane, 16.8 millimoles of n-butyllithium, and 166 millimoles of tetrahydrofuran (THF) were charged into a reactor of 10 liter size equipped with a heater and a stiffer. Secondly, 80 g styrene was added into the solvent to proceed the anionic polymerization at temperature of about 50° C. Thirdly, 640 g of butadiene was added into the reactor, until the reaction of butadiene was complete, Fourthly, 80 g of styrene was added into the reactor. After the polymerization of styrene was complete, 1.6 g of propylene oxide was added to form a styrene-butadiene-styrene triblock copolymer structure with a hydroxyl group at the terminal. This was followed by the addition of methanol to terminate the polymerization. The SBS-OH copolymer had a styrene content of 20 wt % and the 1,2-vinyl bond content in the butadiene block was about 40 mol %.

The SBS-OH copolymer obtained by the above-mentioned steps was then hydrogenated in a pressure vessel using a nickel-2-ethylhexanoate/TEAL catalyst and hydrogen gas. The temperature for the hydrogenation process was controlled from about 40° C. to 100° C. After about 80 mol % of the butadiene block was hydrogenated, the hydrogenation reaction was terminated. And then, the obtained sample was washed with hot acidic water to remove residual catalyst. Finally, the block copolymer was isolated by coagulation in hot water and then dried. The yield of the SEBS-OH copolymer was about 80%.

According to analysis, the obtained SEBS-OH-A copolymer had degree of hydrogenation of 82 mol %, a weight average molecular weight of about 53,000, a molecular weight distribution (weight average molecular weight/number average molecular weight) of 1.03 and MFI of 18 measured at 190° C./5 kgf.

### SEB-OH—B

SEB-OH—B, a hydrogenated styrene-butadiene diblock copolymer having a hydroxyl group at the terminal, was prepared, and characterized as follows.

First, 4800 g of cyclohexane, 12.6 millimoles of n-butyllithium, and 166 millimoles of tetrahydrofuran (THF) were charged into 10 liter size reactor equipped with a heater and a stirrer. Secondly, 160 g styrene was added into the solvent to proceed with the anionic polymerization at temperature of about 50° C. Thirdly, 640 g of butadiene was added into the reactor, until the reaction of butadiene was complete, 1 g of ethylene oxide was added to form a styrene-butadiene diblock copolymer structure with a hydroxyl group at the terminal. This was followed by the addition of methanol to terminate the polymerization. The SB—OH copolymer had a styrene content of 20 wt % and the 1,2-vinyl bond content in the butadiene block was about 40 mol %.

The SB—OH copolymer obtained by the above-mentioned steps was then hydrogenated in a pressure vessel using a nickel-2-ethylhexanoate/TEAL catalyst and hydrogen gas. The temperature for the hydrogenation process was controlled from about 40° C. to 100° C. After about 80 mol % of the butadiene block was hydrogenated, the hydrogenation reaction was terminated. And then, the obtained sample was washed with hot acidic water to remove residual catalyst. Finally, the block copolymer was isolated by coagulation in hot water and then dried. The yield of the SEB-OH copolymer was about 80%.

According to analysis, the obtained SEB-OH—B copolymer had degree of hydrogenation of 85 mol %, a weight average molecular weight of about 64,000, a molecular weight distribution (weight average molecular weight/number average molecular weight) of 1.03 and a f(n) value of about 0.95.

### SEB-OH—C

SEB-OH—C, a hydrogenated styrene-butadiene diblock copolymer having a hydroxyl group at the terminal, was prepared as in the same method of preparing SEB-OH—B, is a hydrogenated styrene-butadiene diblock copolymer having a hydroxyl group at the terminal, which is formed by reacting with ethylene oxide, with a styrene content of 34 wt %, in which the 1,2-vinyl bond content in the butadiene block is about 41 mol % and degree of hydrogenation of 82 mol %. It has a weight average molecular weight of about 55,000 and a molecular weight distribution (weight average molecular weight/number average molecular weight) of 1.03 and a f(n) value of about 0.95.

### SEBS-OH—B

SEBS-OH—B, a hydrogenated styrene-butadiene-styrene triblock copolymer having a hydroxyl group at the terminal, was prepared, and characterized as follows.

First, 4800 g of cyclohexane, 16.8 millimoles of n-butyllithium, and 166 millimoles of tetrahydrofuran (THF) were charged into a reactor of 10 liter size equipped with a heater and a stirrer. Secondly, 120 g styrene was added into the solvent to proceed the anionic polymerization at temperature of about 50° C. Thirdly, 560 g of butadiene was added into the reactor, until the reaction of butadiene was complete, Fourthly, 120 g of styrene was added into the reactor, when the polymerization of styrene was complete, 1.56 g of ethylene oxide was added to form a styrene-butadiene-styrene triblock copolymer structure with a hydroxyl group at the terminal. This was followed by the addition of methanol to terminate the polymerization. The SBS-OH copolymer had a styrene content of 30 wt % and the 1,2-vinyl bond content in the butadiene block was about 40.1 mol %.

The SBS-OH copolymer obtained by the above-mentioned steps was then hydrogenated in a pressure vessel using a nickel-2-ethylhexanoate/TEAL catalyst and hydrogen gas. The temperature for the hydrogenation process was controlled from about 40° C. to 100° C. After about 80 mol % of the butadiene block was hydrogenated, the hydrogenation reaction was terminated. And then, the obtained sample was washed with hot acidic water to remove residual catalyst. Finally, the block copolymer was isolated by coagulation in hot water and then dried. The yield of the SEBS-OH copolymer was about 80%.

According to analysis, the obtained SEBS-OH—B has a degree of hydrogenation of 85.3 mol %, a weight average molecular weight of about 45,000, a molecular weight distribution (weight average molecular weight/number average molecular weight) of 1.03 and a f(n) value of about 0.95.

### SEBS-OH—C

SEBS-OH—C is a hydrogenated styrene-butadiene-styrene triblock copolymer having a hydroxyl group at the terminal. SEBS-OH—C was prepared in the same method of preparing SEBS-OH—B having a hydroxyl group at the terminal, which was formed by reacting with ethylene oxide, with a styrene content of 20 wt %, in which the 1,2-vinyl bond content in the butadiene block is about 40 mol % and degree of hydrogenation of 82 mol %. It has a weight average molecular weight of about 53,000 and a molecular weight distribution (weight average molecular weight/number average molecular weight) of 1.03 and a f(n) value of about 0.95.

SEBS-OH-A and SEB-OH-A were Prepared into Foam as Follows:

Foam of SEBS-OH-A. 100 parts of the SEBS-OH-A hydroxyl-terminated hydrogenated styrenic block copolymer, 0.6 part per hundred (phr) of bis(1-(tert-butylperoxy)-1-methylethyl)-benzene (BIPB) as the organic peroxide, 3.0 phr of azodicarbonamide (AC) as the foaming agent, 10 phr of calcium carbonate, 1 phr of zinc oxide, and 1 phr of steric acid were mixed and kneaded for 10 minutes in a roll mill having a roll surface temperature of 120° C., and the mixture was then molded into a sheet shape. The addition amounts of the BIPB, AC, calcium carbonate, zinc oxide and steric acid were based upon the total weight of the resin components.

After being filled in a press mold, the obtained sheet was pressurized and heated under conditions of 175° C. and about 10 minutes at a pressure of 100 kgf/cm² to obtain the foam. The size of the press mold was 10 mm in thickness, 150 mm in length and 150 mm in width. Subsequently, the foam properties were determined according to the methods described. The results are shown in the following Table 1.

Foam of SEB-OH-A, 100 parts of the SEB-OH-A, 0.35 part per hundred (phr) of bis(1-(tert-butylperoxy)-1-methylethyl)-benzene (BIPB) as the organic peroxide, 3.0 phr of azodicarbonamide (AC) as the foaming agent, 10 phr of calcium carbonate, 1 phr of zinc oxide, and 1 phr of steric acid were mixed and kneaded for 10 minutes in a roll mill having a roll surface temperature of 120° C., and the mixture was then molded into a sheet shape. The addition amounts of the BIPB, AC, calcium carbonate, zinc oxide and steric acid were based upon the total weight of the resin components.

After being filled in a press mold, the obtained sheet was pressurized and heated under conditions of 175° C. and about 10 minutes at a pressure of 100 kgf/cm² to obtain the crosslinked foam with expansion ratio of 160%. The size of the press mold was 10 mm in thickness, 150 mm in length and 150 mm in width. Subsequently, the foam properties were determined according to the methods described. The results are shown in the following Table 1.

### Foam of SEB-OH-A

The foam was prepared and tested according to the same method as that of SEBS-OH-A except with 100 parts of SEB-OH-A, 0.35 phr of BIPB and 3.0 phr of AC. The results are shown in the following Table 1. Both the foam of the hydroxyl-terminated hydrogenated triblock copolymer, SEBS-OH-A, and the foam of the hydroxyl-terminated hydrogenated diblock copolymer, SEB-OH-A, exhibit excellent foam properties.

TABLE 1
Foam Properties

| | | | SEBS-OH-A | SEB-OH-A |
|---|---|---|---|---|
| Density | ASTM D297 | g/cm³ | 0.171 | 0.2 |
| Hardness | ASTM D2240 | Asker C | 29 | 31 |
| Tensile | ASTM D412 | kgf/cm² | 20.37 | 23.8 |
| Elongation | ASTM D412 | % | 225.54 | 322 |
| Split Tear | ASTM D3574 | kgf/cm | 0.659 | 1.07 |
| Compression Set | ASTM D395 | % | 64.74 | 50 |
| Impact resilience | ASTM D2632 | % | 70 | 68 |
| Shrinkage | ASTM D1917 | % | 3 | 1 |

Examples and Comparative Examples listed in Table 3 are foam samples for adhesion evaluation between the foam samples and a vulcanized rubber sheet. The adhesion test employed the aforementioned method of adhesion evaluation of the foams containing hydroxyl terminated hydrogenated block copolymers. The foam samples were prepared according to the same method as that of SEBS-OH-A except with different polymer composition and with varied BIPB and AC contents. The resin composition, and the BIPB and AC contents used in foam formulation of the foam samples are listed in Table 2. For example, Example 1 is a foam by foaming a formulation containing 60 parts of OBC-9530, 40 parts of SEB-OH—B, 0.5 phr of BIPB, and 2.0 phr of AC.

Comparative Example 1 in Table 3 is a foam of EVA 659, which resin is widely used in footwear foam application. The adhesion value is considered a benchmark for assessing the adhesion capability of a foam resin used for footwear foam application.

As shown in Table 3, unlike the foam of polar EVA 659, both foams of POE-8450 and OBC-9530 have very low adhesion. OBC-9530 of an olefin block copolymer of ethylene and 1-octene has even lower adhesion in comparison with POE-8450 of a random copolymer of ethylene and 1-octene. As the EVA 659 content increases, the foams of the blends of EVA 659 with POE 8450 and OBC 9530 respectively exhibit increased adhesion. In the foams containing 40 wt % of EVA, the peel adhesion values of Comparative Example 4 and Comparative Example 7 are still lower than 2 kgf/cm. As the EVA becomes the major phase in Comparative Example 7, the foam exhibits good adhesion. In the case of Comparative Example 6, the presence of 40 wt % of OBC-9530 in the blend greatly reduced the adhesion.

The adhesion of the foams containing the hydroxyl terminated hydrogenated diblock SEB-OH or the triblock SEBS-OH all showed excellent adhesion. It is highly unexpected that the foam samples containing 40 wt % of SEB-OH—B, SEB-OH—C or SEBS-OH—B respectively as a minor phase, still attain high adhesion. In the peel adhesion test of Example 9 of pure SEBS-OH—C, the foam was torn apart due to the strong adhesion at interface.

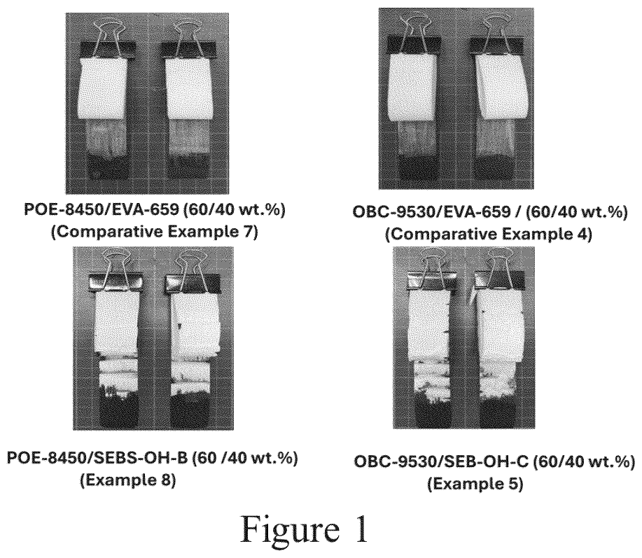

FIG. 1 shows the images of the peeled foam samples after the peel adhesion test. It is clear that the adhesion of Comparative Example 4 and Comparative Example 7 broke in an adhesive failure mode, while the adhesion of Example 5 and Example 8 broke in a cohesive failure mode. Specifically, the fracture location of the foam containing the hydroxyl-terminated hydrogenated styrenic block copolymer occurs within the foam itself, rather than at the adhesive interface. It is evident that the foam comprising the hydroxyl-terminated hydrogenated styrenic block copolymer disclosed herein remaining foam residues on both surfaces demonstrates a higher bonding capability.

TABLE 2
Foam Formulation of Foam Samples

| | Example 1 | Example 2 | Example 3 | Example 4 |
|---|---|---|---|---|
| Ethylene-based | OBC | OBC | OBC | OBC |
| Copolymers | 60 parts | 40 parts | 60 parts | 40 parts |
| Hydroxyl- | SEB-OH-B | SEB-OH-B | SEBS-OH-B | SEBS-OH-B |
| terminated | 40 parts | 60 parts | 40 parts | 60 parts |
| hydrogenated block | | | | |
| copolymer | | | | |
| BIPB | 0.5 | 0.45 | 0.5 | 0.5 |
| (phr) | | | | |
| AC Foaming agent | 2 | 2.2 | 2 | 2.2 |
| (phr) | | | | |
| | Example 5 | Example 6 | Example 7 | Example 8 |
| Ethylene-based | OBC | POE | POE | POE |
| Copolymer | 60 parts | 60 parts | 40 parts | 60 parts |
| Hydroxyl- | SEB-OH-C | SEB-OH-C | SEB-OH-C | SEBS-OH-B |
| terminated | 40 parts | 40 parts | 60 parts | 40 parts |
| hydrogenated block | | | | |
| copolymer | | | | |
| BIPB | 0.5 | 0.5 | 0.45 | 0.45 |
| (phr) | | | | |
| AC Foaming agent | 2 | 2 | 2.2 | 2 |
| (phr) | | | | |
| | | Comparative | Comparative | Comparative |
| | Example 9 | Example 1 | Example 2 | Example 3 |
| Ethylene-based | | EVA | OBC | EVA |
| Copolymer | | 100 parts | 100 parts | 60 parts |
| | | | | OBC |
| | | | | 40 parts |
| Hydroxyl- | SEBS-OH-C | — | — | — |
| terminated | 100 parts | | | |
| hydrogenated block | | | | |
| copolymer | | | | |
| BIPB | 0.5 | 0.5 | 0.8 | 0.6 |
| (phr) | | | | |
| AC Foaming agent | 2 | 1.6 | 2.5 | 1.6 |
| (phr) | | | | |
| | Comparative | Comparative | Comparative | Comparative |
| | Example 4 | Example 5 | Example 6 | Example 7 |
| Ethylene-based | EVA | POE | EVA | EVA |
| Copolymer | 40 parts | 100 parts | 60 parts | 40 parts |
| | OBC | | POE | POE |
| | 60 parts | | 40 parts | 60 parts |
| Hydroxyl- | — | — | — | — |
| terminated | | | | |
| hydrogenated block | | | | |
| copolymer | | | | |
| BIPB | 0.75 | 0.8 | 0.6 | 0.7 |
| (phr) | | | | |
| AC Foaming agent | 1.6 | 2.4 | 1.6 | 1.6 |
| (phr) | | | | |

TABLE 3
Properties of Foam Samples

| | Foam Expand ratio | Peel adhesion |
|---|---|---|
| | (%) | (kgf/cm) |
| Comparative Example 1 | 164 | 3.141 |
| Comparative Example 2 | 200 | 0.45 |
| Comparative Example 3 | 170 | 1.422 |
| Comparative Example 4 | 165 | 0.685 |
| Comparative Example 5 | 196 | 1.119 |
| Comparative Example 6 | 165 | 2.608 |
| Comparative Example 7 | 165 | 1.209 |
| Example 1 | 156 | 2.3 |
| Example 2 | 146 | 2.0 |
| Example 3 | 157 | 2.6 |
| Example 4 | 160 | 1.9 |
| Example 5 | 153 | 2.4 |
| Example 6 | 154 | 3.1 |
| Example 7 | 146 | 3.5 |
| Example 8 | 152 | 3.0 |
| Example 9 | 165 | N.A. |

Although the present disclosure has been explained in relation to its embodiment, it is to be understood that many other possible modifications and variations can be made without departing from the spirit and scope of the disclosure as hereinafter claimed.

1. A foam obtained by foaming a resin composition, which comprises:
a hydroxyl-terminated hydrogenated styrenic block copolymer, wherein the hydroxyl-terminated hydrogenated styrenic block copolymer is a linear block copolymer of formula of:
(A-B)n—OH, (B-A)n—OH, A(B-A)n—OH, or B(A-B)n—OH
where n is 1 to 4, and having a hydroxyl group at the terminal, wherein the A block, prior to hydrogenation, comprises a styrene monomer unit; and the B block, prior to hydrogenation, comprises a conjugated diene monomer unit,
wherein the hydroxyl-terminated hydrogenated styrenic block copolymer comprises 10 to 60 wt % of the A block, and a 1,2-vinyl bond content in the conjugated diene monomer unit of the hydroxyl-terminated hydrogenated styrenic block copolymer is in a range of 5 to 60 mole % prior to hydrogenation; after hydrogenation, 40 mol % or more of the conjugated diene monomer unit is hydrogenated; and the hydroxyl-terminated hydrogenated styrenic block copolymer has a weight average molecular weight of 30000 to 200000.

2. The foam of claim 1, wherein the hydroxyl-terminated hydrogenated styrenic block copolymer is a linear diblock copolymer of formula of A-B—OH or B-A-OH.

3. The foam of claim 1, wherein the hydroxyl-terminated hydrogenated styrenic block copolymer is prepared by sequential polymerization of the A block and the B block in an anionic polymerization process containing a terminal hydroxyl group, and the hydroxyl group is located at either an end of the A block or an end of the B block.

4. The foam of claim 1, wherein the A block is a polymer block of a styrene monomer unit, and the B block is a polymer block of a conjugated diene monomer unit selected from the group consisting of a butadiene unit, an isoprene unit, and a mixture thereof.

5. The foam of claim 1, wherein the A block is a polymer block of a styrene unit and a conjugated diene monomer unit, wherein the conjugated diene monomer unit is a butadiene unit, an isoprene unit, or a mixture thereof, and a content of the conjugated diene monomer unit in the A block is less than or equal to 15 wt % based on a total weight of the A block.

6. The foam of claim 1, wherein the A block is a polymer block of a styrene unit, and the B block is a polymer block of a butadiene unit.

7. The foam of claim 1, wherein the B block is a polymer block of a butadiene unit and a styrene unit, wherein the styrene unit is less than or equal to 20 wt % based on a total weight of the B block.

8. The foam of claim 4, wherein a 1,2-vinyl bond content in the butadiene unit is in a range of 5 to 60 mol % prior to hydrogenation.

9. The foam of claim 5, wherein a 1,2-vinyl bond content in the butadiene unit is in a range of 5 to 60 mol % prior to hydrogenation.

10. The foam of claim 6, wherein a 1,2-vinyl bond content in the butadiene unit is in a range of 5 to 60 mol % prior to hydrogenation.

11. The foam of claim 7, wherein a 1,2-vinyl bond content in the butadiene unit is in a range of 5 to 60 mol % prior to hydrogenation.

12. The foam of claim 4, wherein a 3,4-vinyl bond content in the isoprene unit is in the range of 5 to 60 mol % prior to hydrogenation.

13. The foam of claim 5, wherein a 3,4-vinyl bond content in the isoprene unit is in the range of 5 to 60 mol % prior to hydrogenation.

14. The foam of claim 1, wherein 60 to 95 mol % of the conjugated diene monomer unit is hydrogenated after hydrogenation.

15. A foam obtained by foaming a resin composition, which comprises:
(a) a hydroxyl-terminated hydrogenated styrenic block copolymer, wherein the hydroxyl-terminated hydrogenated styrenic block copolymer is a linear block copolymer of formulas of:
(A-B)n—OH, (B-A)n—OH, A(B-A)n—OH, or B(A-B)n—OH
where n is 1 to 4, and having a hydroxyl group at the terminal, wherein the A block, prior to hydrogenation, comprises a styrene monomer unit; and the B block, prior to hydrogenation, comprises a conjugated diene monomer unit,
wherein the hydroxyl-terminated hydrogenated styrenic block copolymer comprises 10 to 60 wt % of the A block, and a 1,2-vinyl bond content in the conjugated diene monomer unit of the hydroxyl-terminated hydrogenated styrenic block copolymer is in a range of 5 to 60 mole % prior to hydrogenation; after hydrogenation, 40 mol % or more of the conjugated diene monomer unit is hydrogenated; and the hydroxyl-terminated hydrogenated styrenic block copolymer has a weight average molecular weight of 30000 to 200000; and
(b) an ethylene-based copolymer,
wherein a weight ratio of the hydroxyl-terminated hydrogenated styrenic block copolymer to the ethylene-based copolymer, is from 90/10 to 10/90.

16. The foam of claim 15, wherein the ethylene-based copolymer is an ethylene-vinyl acetate copolymer, an olefin block copolymer comprising a polymer block of an ethylene unit, an ethylene alpha-olefin based random copolymer, a polyethylene, or a mixture thereof.

17. The foam of claim 15, wherein the ethylene-based copolymer is an ethylene-vinyl acetate copolymer, and a vinyl acetate content of the ethylene-vinyl acetate copolymer is in the range of 15 to 40 wt % based on a total weight of the ethylene-vinyl acetate copolymer.

18. The foam of claim 15, wherein the ethylene-based copolymer is an ethylene alpha-olefin based random copolymer consisting of an ethylene unit and an octene unit.

19. The foam of claim 15, wherein the ethylene-based copolymer is an olefin block copolymer comprising a polymer block of an octene unit.

20. The foam of claim 15, wherein the ethylene-based copolymer is an olefin block copolymer having a melting temperature in the range of 110° C. to 130° C. and a density ranging from 0.875 g/cc to 0.945 g/cc.

21. A foam obtained by foaming a resin composition, which comprises:
(a) a hydroxyl-terminated hydrogenated styrenic block copolymer, wherein the hydroxyl-terminated hydrogenated styrenic block copolymer is a linear block copolymer of formulas of:
(A-B)n—OH, (B-A)n—OH, A(B-A)n—OH, or B(A-B)n—OH
where n is 1 to 4, and having a hydroxyl group at the terminal, wherein the A block, prior to hydrogenation, comprises a styrene monomer unit; and the B block, prior to hydrogenation, comprises a conjugated diene monomer unit,
wherein the hydroxyl-terminated hydrogenated styrenic block copolymer comprises 10 to 60 wt % of the A block, and a 1,2-vinyl bond content in the conjugated diene monomer unit of the hydroxyl-terminated hydrogenated styrenic block copolymer is in a range of 5 to 60 mole % prior to hydrogenation; after hydrogenation, 40 mol % or more of the conjugated diene monomer unit is hydrogenated; and the hydroxyl-terminated hydrogenated styrenic block copolymer has a weight average molecular weight of 30000 to 200000; and
(b) a polar thermoplastic elastomer,
wherein a weight ratio of the hydroxyl-terminated hydrogenated styrenic block copolymer to the polar thermoplastic elastomer, is from 90/10 to 10/90.

22. The foam of claim 21, wherein the polar thermoplastic elastomer is a thermoplastic polyurethane (TPU), a thermoplastic polyester elastomer(TPEE), a polyether block amide (PEBA) or a combination thereof, wherein the polar thermoplastic elastomer has a hardness measured in shore A in the range of 60A to 90A, and a melting temperature in the range of 140° C. to 200° C.

23. The foam of claim 1, which is obtained by a process comprising injection molding the resin composition in an injection mold, wherein the process includes:
crosslinking the resin composition using an organic peroxide initiator, and foaming the resin composition using a chemical foaming agent,
wherein the temperature of crosslinking in the injection mold is about 150° C. to about 200° C.

24. The foam of claim 23, wherein the organic peroxide initiator is bis(1-(tert-butylperoxy)-1-methylethyl)-benzene.

25. The foam of claim 23, wherein the chemical foaming agent is azodicarbonamide.

26. The foam of claim 23, wherein a crosslinking co-agent or a functional chain extender is further used in crosslinking the resin composition, wherein the functional chain extender comprises at least one functional group selected from the group consisting of anhydride, epoxy and isocyanate to react with the terminal hydroxyl group of the hydroxyl-terminated hydrogenated styrenic block copolymer.

27. The foam of claim 23, which has a foam density in a range of 0.1 to 0.5 g/cm³, impact resilience within a range of 50% to 80%, and a hardness (Asker C) in a range of 20 to 70.

28. An article manufactured from the foam of claim 1, which is a component of footwear.

29. The article of claim 28, wherein the component of the footwear is a midsole.

30. A resin composition, which comprises:
a hydroxyl-terminated hydrogenated styrenic block copolymer, wherein the hydroxyl-terminated hydrogenated styrenic block copolymer is a linear block copolymer of formulas of:
(A-B)n—OH, (B-A)n—OH, A(B-A)n—OH, or B(A-B)n—OH
where n is 1 to 4, and having a hydroxyl group at the terminal, wherein the A block, prior to hydrogenation, comprises a styrene monomer unit; and the B block, prior to hydrogenation, comprises a conjugated diene monomer unit,
wherein the hydroxyl-terminated hydrogenated styrenic block copolymer comprises 10 to 60 wt % of the A block, and a 1,2-vinyl bond content in the conjugated diene monomer unit of the hydroxyl-terminated hydrogenated styrenic block copolymer is in a range of 5 to 60 mole % prior to hydrogenation; after hydrogenation, 40 mol % or more of the conjugated diene monomer unit is hydrogenated; and the hydroxyl-terminated hydrogenated styrenic block copolymer has a weight average molecular weight of 30000 to 200000.

31. The resin composition of claim 30, further comprising an ethylene-based copolymer.

32. A use of the resin composition of claim 30, for preparing a foam.
